(19) United States
(12) Patent Application Publication
(10) Pub. No.: US 2009/0286130 A1
(43) Pub. Date: Nov. 19, 2009

(54) Water Repellent Layer-Forming Tape

(76) Inventors: Masahiro Imanishi, Shizuoka-ken (JP); Haruyuki Nakanishi, Shizuoka-ken (JP); Shigeaki Murata, Shizuoka-ken (JP); Yoshihisa Tamura, Shizuoka-ken (JP)

Correspondence Address: KENYON & KENYON LLP, 1500 K STREET N.W., SUITE 700, WASHINGTON, DC, 20005, US

(21) Appl. No.: 11/990,447

(22) PCT Filed: Aug. 30, 2006
(86) PCT No.: PCT/JP2006/317589

§ 371 Date: Mar. 11, 2008

(30) Foreign Application Priority Data
Aug. 31, 2005 (JP) 2005-251354

(51) Int. Cl. H01M 2/02; B32B 27/12

(52) U.S. Cl. 429/34; 428/292.1; 428/297.4

(57) ABSTRACT

The present invention mainly intends to provide a water-repellent layer-forming tape, which enables a water-repellent layer to be provided by a simple method. In order to achieve the object, the present invention provides a water-repellent layer-forming tape to be used for forming a water-repellent layer of a tube-type fuel cell, comprising a plurality of fibrous shape-retaining materials and a water-repellent portion formed to connect the plurality of fibrous shape-retaining materials, wherein the water-repellent portion contains a water-repellent material and an electro-conductive material.

### TECHNICAL FIELD

The present invention relates to a water repellent layer-forming tape, which enables a water-repellent layer to be provided by a simple method.

### BACKGROUND ART

A unit cell which is a minimum electric generating cell unit of a prior art solid polymer electrolyte type fuel cell having a flat-plate structure (herein after referred briefly to “flat-type fuel cell” in some cases) generally has a membrane electrode assembly in which catalytic electrode layers are connected to both sides of a solid electrolyte membrane. Further, gas diffusion layers are disposed on both sides of the membrane electrode assembly. Further, separators each having a gas flow passage are disposed on outer sides of the gas diffusion layers. The separator functions to flow a fuel gas and an oxidant gas fed into the catalytic electrode layers via the gas-diffusion layers and to conduct an electric current obtained by electric generation to the outside.

In order to miniaturize the flat-type fuel cell and enlarge the electric generating reaction area per unit volume, the thicknesses of the constituting members of the flat-type fuel cell need to be small. In such conventional flat-type fuel cells, it is not preferable from the standpoint of the function and the strength to make the thickness of each constituting member small to a certain value or less, so that they are reaching the design limit. Under the circumstances, tubular or columnar fuel cells in which respective layers constituting the fuel cell are laminated coaxially have been developed.

For example, Patent document 1 discloses a tube-type fuel cell in which an inner current collector, an inner catalytic electrode layer, a solid electrolyte membrane, an outer catalytic electrode layer, an outer current collector are provided coaxially and in sequence order from the inner side. This tube-type fuel cell has gas flow passages on the outer peripheral face of the inner current collector and on the inner peripheral face of the outer current collector. Since such tube-type fuel cells can be closely arranged in a given space when the diameter of the fuel cells is smaller, the electrode area per unit volume can be largely increased as compared with the conventional flat-type fuel cell.

In such a tube-type fuel cell, water (H₂O) is produced by the reaction with hydrogen (H₂) and oxygen (O₂) during operation. When the produced water remains in the catalytic electrode layers, it covers the surface of the catalyst, which hinders contact between the catalyst and the hydrogen gas or the oxygen gas to decrease the current generation efficiency of the tube-type fuel cell. Therefore, the produced water needs to be effectively drained outside from the tubular fuel cell. In general, drainability is improved by providing a water-repellent layer between the catalytic electrode layer and the current collector. For such a water-repellent layer, for example, water-repellent materials such as a fluororesin or the like are used.

As a method of forming the water-repellent layer, there is available a method in which a water repellent layer forming-composition containing a water-repellent material is coated on a current collector, and then the water-repellent material is melted by heating. Since steps of this method may be troublesome, a simple method to form the water-repellent layer has been desired. Further, Patent Document 1 discloses a water-repellent layer formed by wrapping the tube-type fuel cell with carbon fibers in a tubular form which have been subjected to water-repellent treatment with a dispersion of a polytetrafluoroethylene (PTFE). However, since the water-repellent layer described in Patent Document 1 has a possibility that the clearance between carbon fibers gets larger when being wrapped, flooding may occur in the clearance portion due to a reduced heat retention effect.

Patent Document 1: Japanese Patent Application Laid-Open No. 2002-124273

### DISCLOSURE OF THE INVENTION

The present invention has been made in view of the above problems, and it is a main object of the present invention to provide a water repellent layer-forming tape, which enables a water-repellent layer to be provided by a simple method.

In order to achieve the object, the present invention provides a water repellent layer-forming tape to be used for forming a water-repellent layer of a tube-type fuel cell, comprising a plurality of fibrous shape-retaining materials and a water-repellent portion formed to connect the plurality of fibrous shape-retaining materials, wherein the water-repellent portion contains a water-repellent material and an electroconductive material.

According to the present invention, the water repellent layer-forming tape has a tape-like shape, and the water-repellent layer can be easily formed by winding the tape around an inner current collector or an outer catalytic electrode layer. Further, according to the present invention, tensile strength can be enhanced by using the fibrous shape-retaining material, and the water-repellent layer having excellent adhesion can be formed.

In the above invention, it is preferable that a fiber direction of the fibrous shape-retaining material is in parallel to a longitudinal direction of the water repellent layer-forming tape. This is because the break of the water repellent layer-forming tape can be suppressed when the water repellent layer-forming tape is wound, for example spirally, while being pulled in the longitudinal direction in forming the water-repellent layer, and the water-repellent layer having excellent adhesion can be formed.

In the above invention, it is preferable that the fibrous shape-retaining material is a carbon fiber. This is because the water repellent layer-forming tape having excellent electroconductivity can be obtained.

In the above invention, it is preferable that the water-repellent material is a fluororesin and the electroconductive material is a carbon black.

The present invention provides a tube-type fuel cell using the above water repellent layer-forming tape.

According to the present invention, it is advantageous that the water-repellent layer can be easily formed by using the water repellent layer-forming tape.

In the above invention, it is preferable that the water repellent layer-forming tape is spirally wound. The water-repellent layer can be formed without a gap by spirally winding the water repellent layer-forming tape, so that the heat-retaining effect can be enhanced to suppress the occurrence of flooding.

The present invention exhibits the effect that the water-repellent layer can be formed easily between the inner current collector and the inner catalytic electrode layer and/or between the outer current collector and the outer catalytic electrode layer by the simple method.

### BRIEF DESCRIPTION OF THE DRAWINGS

FIG. 1 is a schematically plane view showing an example of the water repellent layer-forming tape of the present invention.

FIGS. 2A and 2B give schematic views illustrating arrangements of the fibrous shape-retaining material to be used in the present invention.

FIGS. 3A to 3C give schematic plane views illustrating water repellent layer-forming tapes of the present invention.

FIGS. 4A and 4C give schematic plane views illustrating further water repellent layer-forming tapes of the present invention.

FIG. 5 is a schematic view illustrating an example of a tube-type fuel cell of the present invention.

FIGS. 6A and 6B give schematic views illustrating ways of winding the water repellent layer-forming tape of the present invention.

FIG. 7 is a schematic view illustrating a way of winding the water repellent layer-forming tape.

FIG. 8 is a schematic view for illustrating a water-repellent layer to be used in the present invention.

### BEST MODE FOR CARRYING OUT THE INVENTION

In the following, the water repellent layer-forming tape of the present invention and the tube-type fuel cell using the same will be explained in detail.

A. Water Repellent Layer-Forming Tape

First, the water repellent layer-forming tape of the present invention will be explained. The water repellent layer-forming tape of the present invention is characterized by being used for forming a water-repellent layer of a tube-type fuel cell, and comprising a plurality of fibrous shape-retaining materials and a water-repellent portion formed to connect the plurality of fibrous shape-retaining materials, wherein the water-repellent portion contains a water-repellent material and an electroconductive material.

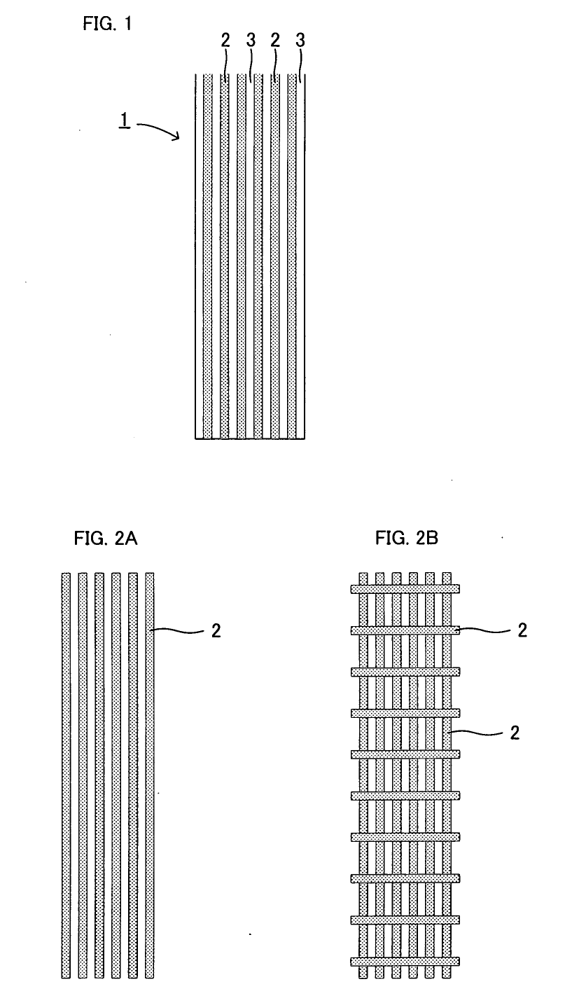

FIG. 1 is a schematic plane view illustrating an example of the water repellent layer-forming tape of the present invention. The water repellent layer-forming tape 1 comprises a plurality of fibrous shape-retaining materials 2, and water-repellent portion 3 formed for connecting the plurality of fibrous shape-retaining materials 2, wherein the water-repellent portion 3 contains a water-repellent material and an electroconductive material. Not shown in FIG. 1, the water repellent layer-forming tape has a gas-permeable porous structure since the tape is used to form the water-repellent layer of the tube-type fuel cell. Further, in the water repellent layer-forming tape 1 shown in FIG. 1, the fiber direction of the fibrous shape-retaining material 2 is set in parallel to the longitudinal direction of the tape.

In the following, respective constituent elements of the water repellent layer-forming tape will be explained.

1. Fibrous Shape-Retaining Material

First, the shape-retaining material to be used in the present invention will be explained. The shape-retaining material is a fibrous material for imparting strength to the water repellent layer-forming tape.

A plurality of the fibrous shape-retaining materials is contained in the water repellent layer-forming tape, and their arrangements are not particularly limited. For example, as shown in FIG. 2A, each fibrous shape-retaining material 2 may be arranged to be parallel, or as shown in FIG. 2B, each fibrous shape-retaining material 2 may be arranged to be cross. Among them, it is preferable in the present invention that the each fibrous shape-retaining material is arranged to be parallel. As compared with the case where the each fibrous shape-retaining material 2 is arranged to be cross, the thickness of the water repellent layer-forming tape can be made smaller. As a result, the thickness of the water-repellent layer obtained is also smaller, so that the tube-type fuel cell having a smaller size and a higher electric generating efficiency can be obtained.

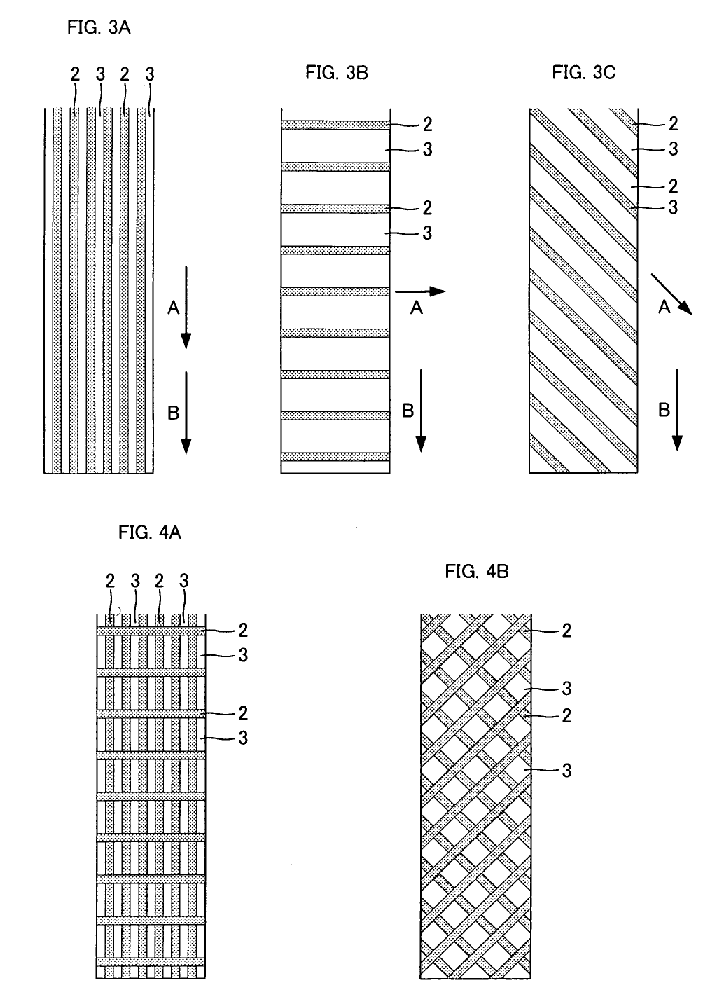

Specific examples of the water repellent layer-forming tape in which each fibrous shape-retaining material is arranged to be parallel include; a case where, as shown in FIG. 3A, the fiber direction A of the fibrous shape-retaining material 2 is in parallel to the longitudinal direction B of the water repellent layer-forming tape, a case where, as shown in FIG. 3B, the fiber direction A of the fibrous shape-retaining material 2 is vertical to the longitudinal direction B of the water repellent layer-forming tape, and a case where, as shown in FIG. 3C, the fiber direction A of the fibrous shape-retaining material 2 has a given angle to the longitudinal direction B of the water repellent layer-forming tape. In FIGS. 3A to 3C, the water-repellent portion 3 is formed to connect the fibrous shape-retaining material 2.

In the present invention, it is preferable that the fiber direction of the fibrous shape-retaining material is in parallel to a longitudinal direction of the water repellent layer-forming tape. This is because the break of the water repellent layer-forming tape can be suppressed when the water repellent layer-forming tape is wound, for example spirally, while being pulled in the longitudinal direction in forming the water-repellent layer, and the water-repellent layer having excellent adhesion can be formed.

Meanwhile, specific examples of the water repellent layer-forming tape in which each fibrous shape-retaining material is arranged to be cross include, as shown in FIGS. 4A and 4B, each fibrous shape-retaining material 2 is arranged to be cross, and the water-repellent portion 3 is formed to connect the fibrous shape-retaining material 2.

Meanwhile, since the fibrous shape-retaining material is used to improve the shape retainability of the water repellent layer-forming tape, they may have electroconductivity or no electroconductivity. Among them, in the present invention, the fibrous shape-retaining material preferably has electroconductivity. This is because, while the water repellent layer-forming tape of the present invention contains the electroconductive material mentioned later, the water repellent layer-forming tape having more excellent electroconductivity can be obtained when the fibrous shape-retaining material has electroconductivity.

The Fiber length of the fibrous shape-retaining material differs depending upon the above-mentioned arrangements thereof, and is not particularly limited. The fiber diameter of the fibrous shape-retaining material differs depending upon the above-mentioned arrangements thereof, and is preferably in a range of 0.1 to 10 μm, more preferably in a range of 1 to 7 μm. Further, for example, in case where the each fibrous shape-retaining material is arranged to be parallel, the distance (pitch) between the adjacent fibrous shape-retaining materials is preferably in a range of 0 to 1 μm, and more preferably in a range of 0 to 0.1 μm.

Such a fibrous shape-retaining material is not particularly limited, so long as it can impart strength to the water repellent layer-forming tape. Examples thereof include a carbon fiber, a metallic fiber, a resin fiber, and among them a carbon fiber is preferable. Further, specific examples of the carbon fiber include a rayon-based carbon fiber, a polyacrylonitrile (PAN)-based carbon fiber, a pitch-based carbon fiber.

The content of the fibrous shape-retaining material in the water repellent layer-forming tape is not particularly limited, and is preferably in a range of 30 to 90 mass % and more preferably in a range of 50 to 70 mass %.

2. Water-Repellent Portion

Next, the water-repellent portion in the present invention will be explained. The water-repellent portion in the present invention is formed to connect the plurality of fibrous shape-retaining materials, and contains the water-repellent material and the electroconductive material.

The water-repellent material is a material to impart water repellency to the water repellent layer-forming tape. The water-repellent material is not particularly limited, so long as it has water repellency. An example thereof includes a fluororesin. Specific examples of the fluororesin include polytetrafluoroethylene (PTFE), ethylene-tetrafluoroethylene copolymer (ETFE), tetrafluoroethylene-perfluoroalkyl vinyl ether copolymer (PFA), perfluoroethylenepropene copolymer (FEP), fluorinated vinylidene-tetrafluoroethylene-hexafluoropropylene copolymer, polyfluorinated vinylidene, fluoroolefin-hydrocarbon-based copolymer, fluoroacrylate copolymer, fluoroepoxy compound, and Among them, polytetrafluoroethylene (PTFE) is preferable in the present invention. This is because the water repellent layer-forming tape having excellent water repellency can be obtained.

The content of the water-repellent material in the water repellent layer-forming tape is not particularly limited, and is preferably in a range of 10 to 70 mass % and more preferably in a range of 20 to 50 mass %.

Meanwhile, the electroconductive material is a material to impart electroconductivity to the water repellent layer-forming tape. The electroconductive material is not particularly limited, so long as it has electroconductivity. Examples thereof include electroconductive particles such as carbon black. Specific examples of the carbon black include oil furnace black, acetylene black, thermal black, and channel blacks. Among them, oil furnace black and acetylene black are preferable, because they have excellent electroconductivity-imparting effect. Further, the diameter of the primary particle of the electroconductive particle is not particularly limited, and is preferably not more than 1 μm.

The content of the electroconductive material in the water repellent layer-forming tape is not particularly limited, and is preferably in a range of 5 to 50 mass % and more preferably in a range of 10 to 30 mass %.

3. Water Repellent Layer-Forming Tape

The water repellent layer-forming tape of the present invention is used to form the water-repellent layer of the tube-type fuel cell. Herein, the water-repellent layer of the tube-type fuel cell can be broadly classified into an inner water-repellent layer and an outer water-repellent layer. Usually, the inner water-repellent layer is disposed between the inner current collector and the inner catalytic electrode layer, and the outer water-repellent layer is disposed between the outer current collector and the outer catalytic electrode layer. The water repellent layer-forming tape of the present invention can be used for any of the inner water-repellent layer and the outer water-repellent layer. Particularly, the tape is preferably used for the outer water-repellent layer. This is because, in forming the outer water-repellent layer on a solid electrolyte membrane formed, the conventional method of forming the water-repellent layer, which is the method by melting the water-repellent material under heating, could degrade the solid electrolyte membrane or the like with heat; on the other hand, when the water repellent layer-forming tape of the present invention is used, it is not necessary to melt the water-repellent material under heating, thereby the outer water-repellent layer can be formed without degrading the solid electrolyte membrane.

Further, the thickness of the water repellent layer-forming tape of the present invention is not particularly limited, and is preferably in a range of 1 to 100 μm, more preferably in a range of 5 to 50 μm, and still more preferably in a range of 5 to 20 μm. The width of the water repellent layer-forming tape of the present invention is not particularly limited, and is preferably in a range of 0.1 to 3 cm, more preferably in a range of 0.2 to 1 cm, and still more preferably in a range of 0.2 to 0.5 cm.

The water repellent layer-forming tape of the present invention may be stored in a rolled state. Rolling can save the space. Further, in case that the surface of the rolled water repellent layer-forming tape may stick to each other, a releasing layer may be provided on one of the surfaces of the water repellent layer-forming tape.

4. Method for Producing the Water Repellent Layer-Forming Tape

Next, the method for producing the water repellent layer-forming tape will be explained. The method for producing water repellent layer-forming tape is not particularly limited, so long as it can obtain the above-mentioned water repellent layer-forming tape. A specific example includes a method in which a water repellent portion forming-composition composed of a water-repellent material, an electroconductive material and a solvent is first prepared, and then the water repellent portion forming-composition is coated on fibrous shape-retaining material, for example, arranged shown in FIG. 2A, and then heating it. The heating temperature on heating is not particularly limited, but heating is carried out near a temperature at which the water-repellent material is melted. It is ordinarily around 350° C.

B. Tube-Type Fuel Cell

Next, the tube-type fuel cell of the present invention will be explained. The tube-type fuel cell is characterized by using the above-mentioned water repellent layer-forming tape.

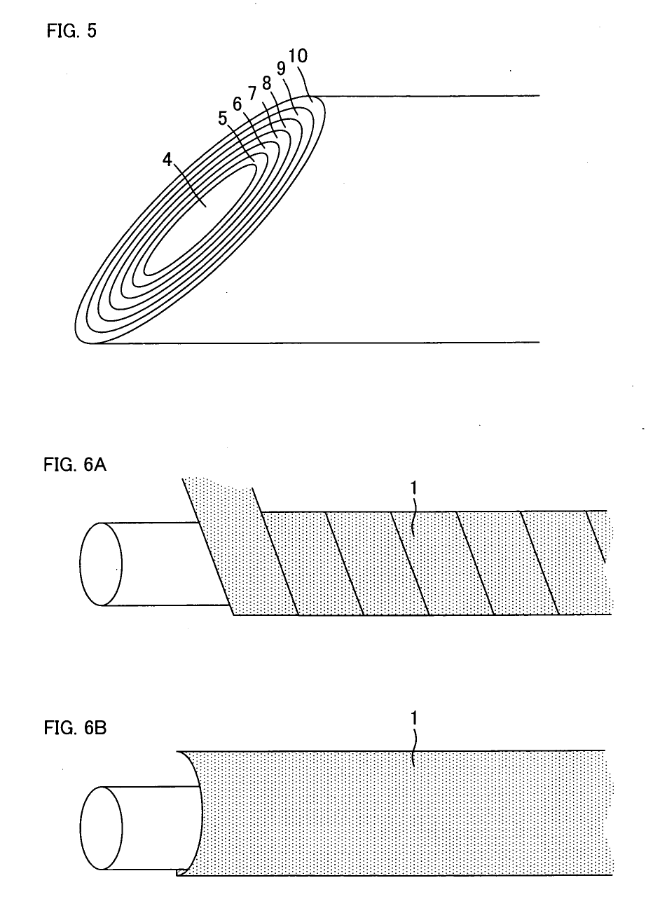

FIG. 5 is a schematic view for illustrating an example of the tube-type fuel cell of the present invention. In the tube-type fuel cell of the present invention, an inner water-repellent layer 5, an inner catalytic electrode layer 6, a solid electrolyte membrane 7, an outer catalytic electrode layer 8, an outer water-repellent layer 9 and an outer current collector 10 are successively formed starting from an inner current collector 4 having a cylindrical shape. At least one of the inner water-repellent layer 5 and the outer water-repellent layer 9 is made of the above-mentioned water repellent layer-forming tape.

In the following, the water-repellent layer to be used in the present invention as well as other members constituting the tube-type fuel cell will be explained.

1. Water-Repellent Layer

First, the water-repellent layer to be used in the present invention will be explained. The water-repellent layer to be used in the present invention can be broadly classified into the inner water-repellent layer and the outer water-repellent layer. Ordinarily, the inner water-repellent layer is disposed between the inner current collector and the inner catalytic electrode layer, and the outer water-repellent layer is disposed between the outer current collector and the outer catalytic electrode layer.

The tube-type fuel cell of the present invention is not particularly limited, so long as at least one of the inner water-repellent layer and the outer water-repellent layer is made of the above-mentioned water repellent layer-forming tape. That is, the inner water-repellent layer or the outer water-repellent layer may be formed by the water repellent layer-forming tape, or the inner water-repellent layer and the outer water-repellent layer may be formed by the water repellent layer-forming tape. In the present invention, it is particularly preferable that the outer water-repellent layer is formed by the water repellent layer-forming tape. According to the conventional method, the solid electrolyte membrane or the like could be degraded during the formation of the outer water-repellent layer, but when the water repellent layer-forming tape is used, the outer water-repellent layer can be formed without deteriorating the solid electrolyte membrane or the like.

Further, the water-repellent layer to be used in the present invention is formed by winding the water repellent layer-forming tape around the outer peripheral face of the inner current collector or the outer catalytic electrode layer. A way of winding the water repellent layer-forming tape is not particularly limited. Examples thereof include a way of spiral winding as shown in FIG. 6A, a way of wrapping as shown in FIG. 6B. Among them, the way of spiral winding is preferable.

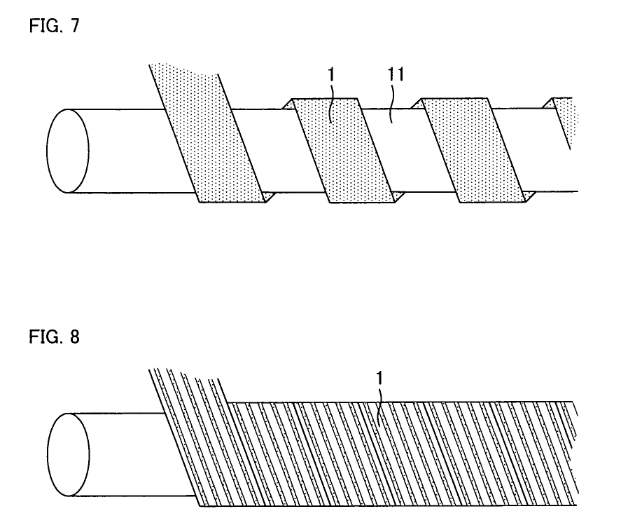

In case that the water repellent layer-forming tape is wound spirally, it is preferable that no gap is present between adjacent portions of the water repellent layer-forming tape. This is because, as shown in FIG. 7, it is feared that the heat-retaining effect is decreased to cause flooding when gaps 11 are formed between the adjacent portions of the water repellent layer-forming tape 1. As the case where no gap is present between the adjacent portions of the water repellent layer-forming tape, mention may be specifically made of a case where the adjacent portions of the water repellent layer-forming tape are overlapped (overlapped portions) and a case where neither lapping nor gap is present between the adjacent portions of the water repellent layer-forming tape. Particularly, in the present invention, it is preferable that the adjacent portions of the water repellent layer-forming tape are overlapped. This is because formation of gaps can be suppressed even if vibration or the like occurs. The overlap amount of the overlapped portions is not particularly limited, and is preferably in a range of 10 to 50%, and more preferably in a range of 30 to 50% to the width of the water repellent layer-forming tape.

Particularly, in case that the water repellent layer-forming tape is wound spirally, the fiber direction of the fibrous shape-retaining material contained in the water repellent layer-forming tape is preferably in parallel to the longitudinal direction of the water repellent layer-forming tape. This is because the break of the water repellent layer-forming tape can be suppressed when the water repellent layer-forming tape is wound while being pulled in the longitudinal direction in forming the water-repellent layer, and the water-repellent layer having excellent adhesion can be formed. A specific example of the water-repellent layer obtained with such a water repellent layer-forming tape by the winding method is shown in FIG. 8.

In the present invention, after the water repellent layer-forming tape is wound around the outer peripheral face of the inner current collector or the outer catalytic electrode layer, thermocompression bonding may be performed. This is because the adhesion thereof can be improved.

2. Other Members

Next, other members constituting the tube-type fuel cell will be explained. The tube-type fuel cell of the present invention is not particularly limited, so long as it has the above water-repellent layer. In addition to the water-repellent layer, the fuel cell usually comprises an inner current collector, an inner catalytic electrode layer, a solid electrolyte membrane, an outer catalytic electrode layer and an outer current collector.

(1) Inner Current Collector

The inner current collector to be used in the present invention is provided with a gas flow passage in an outer peripheral face to collect electrons generated by an electric generating reaction. Usually, it is installed inner peripheral face of the inner water-repellent layer. The shape of the inner current collector is not particularly limited, but generally cylindrical. Further, the inner current collector may be a hollow inner current collector, in this way, reduction in the material of the inner current collector and reduction in weight thereof can be attained. Furthermore, when a heat medium or a coolant is flown in a hollow portion, the tube-type fuel cell can be heated or cooled. Further, as the material for the inner current collector, one having high electroconductivity and corrosion resistance is preferred. Such a material is not particularly limited, but specific examples thereof include titanium, stainless steel, platinum, gold, SiO₂, B₂O₃, Nd₂O, titanium-based alloys such as TiC, TiSi₂ and TiB₂, carbon, electroconductive ceramics, and electroconductive resins.

(2) Inner Catalytic Electrode Layer

The inner catalytic electrode layer to be used in the present invention is a layer offering a reacting field where the electric generating reaction occurs, and usually disposed between the inner current collector and the solid electrolyte membrane. As the inner catalytic electrode layer, one similar to the catalytic electrode layer used in the general flat-type fuel cell can be used, and no limitation is imposed upon it. An example thereof includes an inner catalytic electrode layer comprising an electrolyte material such as a perfluorosulfonic acid-based polymer, an electroconductive material such as carbon black and a catalyst such as platinum. Further, the thickness of the inner catalytic electrode layer is not particularly limited, and is preferably in a range of 1 to 100 μm and more preferably in a range of 5 to 20 μm.

(3) Solid Electrolyte Membrane

The solid electrolyte membrane to be used in the present invention is a layer which is usually disposed between the inner catalytic electrode layer and the outer catalytic electrode layer and which functions to conduct protons between the inner catalytic electrode layer and the outer catalytic electrode layer. As the solid electrolyte membrane, one similar to the catalytic electrode layer employed in the general flat-type fuel cell can be used, and no limitation is imposed upon it. Specific examples thereof include perfluorosulfonic acid-based polymers represented by Nafion (trade name, manufactured by DuPont), and hydrocarbon-based resins represented by amide-based resins.

Furthermore, as other example of the solid electrolyte membrane, an inorganic solid electrolyte membrane composed mainly of an oxide of silicon can be cited. Examples of the inorganic solid electrolyte membrane include a solid electrolyte membrane using a porous glass, and a solid electrolyte membrane using a phosphate glass. An Example of the solid electrolyte membrane using the porous glass includes one obtained by reacting a silane coupling agent such as mercaptopropyltrimethoxy silane with OH groups at inner surfaces of fine pores of the porous glass, and then introducing proton-conductive sulphonic groups by oxidizing the mercapto groups (—SH). With respect to this producing method, “Chemistry and Chemical Industry”, Vol. 57, No. 1 (2004), pp 41-44, can be referred. On the other hand, as to the solid electrolyte membrane using the phosphate glass, “Fuel Cells”, Vol. 3, No. 3, 2004, pp 69-71, can be referred.

(4) Outer Catalytic Electrode Layer

The outer catalytic electrode layer to be used in the present invention is a layer which offers a reacting field where an electric generating reaction occurs and which is usually disposed between the solid electrolyte membrane and the outer water-repellent layer. As the outer catalytic electrode layer, what is described in connection with the above “(2) Inner Catalytic Electrode Layer” is also applicable, and therefore explanation thereof is omitted here.

(5) Outer Current Collector

The outer current collector to be used in the present invention is one which collects electrons generated in the electric generating reaction and which is usually disposed on the outer side of the outer water-repellent layer. The shape of the outer current collector is not particularly limited, so long as it enables the gas to flow in radial directions of the tube-type fuel cell. A spring-like shape, a network shape, a helical shape, etc. can be cited, and among them the spring-like shape is preferable. Furthermore, the outer current collector may be a cylindrical one partially formed with pores. As the material for the outer current collector, a material having high electroconductivity is preferable. Such a material is not particularly limited. However, it is similar to the materials described in the above “(1) Inner Current Collector”, and the explanation is omitted here.

The invention is not restricted to the above embodiments. The embodiments are only exemplifications. All that have configurations and advantages substantially same as that of technical ideas described in claims according to the invention are included in the technical ranges of the invention.

### EXAMPLES

Hereinafter, the invention will be more specifically described with reference to examples.

### Example 1

Equal amounts of PTFE (water-repellent material) and acetylene black (electroconductive material) were dispersed in water, thereby obtaining a water-repellent portion forming composition. Next, a polyacrylonitrile-based carbon fiber (fibrous shape-retaining material, fiber diameter 5 μm, fiber length 1000 mm) were disposed such that the fiber direction thereof was in parallel to the longitudinal direction of a water repellent layer-forming tape. At that time, the distance (pitch) between each carbon fiber was set at 0. Thereafter, the water repellent portion forming-composition was coated onto the carbon fiber, which was heated at 300° C., thereby obtaining a water repellent layer-forming tape. The water repellent layer-forming tape obtained was composed of 60 mass % of the carbon fiber, 20 mass % of the PTFE and 20 mass % of the acetylene black, and the width of the tape was 2 mm.

### Example 2

Around to an assembly in which an inner current collector, an inner water-repellent layer, an inner catalytic electrode layer, a solid electrolyte membrane and an outer catalytic electrode layer were formed successively from the inner side, an outer water-repellent layer was formed by spirally winding the water repellent layer-forming tape obtained in Example 1 and cutting it. At that time, the water repellent layer-forming tape was wound such that adjacent portions of the tape lapped at 30% of the width of the tape. Thereafter, a membrane-electrode assembly (MEA) was obtained by thermally compression bonding the outer water-repellent layer and winding an outer current collector.

1. A water-repellent layer-forming tape to be used for forming a water-repellent layer of a tube-type fuel cell, comprising a plurality of fibrous shape-retaining materials and a water-repellent portion formed to connect the plurality of fibrous shape-retaining materials, wherein the water-repellent portion contains a water-repellent material and an electro-conductive material.

2. The water-repellent layer-forming tape according to claim 1, wherein a fiber direction of the fibrous shape-retaining material is in parallel to a longitudinal direction of the water-repellent layer-forming tape.

3. The water-repellent layer-forming tape according to claim 1, wherein the fibrous shape-retaining material is a carbon fiber.

4. The water-repellent layer-forming tape according to claim 1, wherein the water-repellent material is a fluororesin and the electro-conductive material is a carbon black.

5. A tube-type fuel cell using the water-repellent layer-forming tape according to claim 1.

6. The tube-type fuel cell according to claim 5, wherein the water-repellent layer-forming tape is spirally wound.
